(19) United States
(12) Patent Application Publication
(10) Pub. No.: US 2025/0370735 A1
(43) Pub. Date: Dec. 4, 2025

(54) DEFINING HIERARCHICAL ENGINEERING SYSTEMS

(71) Applicant: SRI International, Menlo Park, CA (US)

(72) Inventors: Matthew Patterson, Menlo Park, CA (US); Randi Wang, Menlo Park, CA (US); Morad Behandish, San Mateo, CA (US)

(21) Appl. No.: 19/222,540

(22) Filed: May 29, 2025

Related U.S. Application Data
(60) Provisional application No. 63/654,799, filed on May 31, 2024.

(51) Int. Cl. G06F 8/41; G06F 8/30

(52) U.S. Cl. CPC G06F 8/443; G06F 8/315

(57) ABSTRACT

In an example, a method for solving problems involving a Hierarchical Physical and/or Engineering System (HPES) includes: receiving, by a computing system, a declarative object-oriented definition of the HPES having one or more sub-systems and/or one or more components; receiving, by the computing system, a definition of a first problem to be solved, wherein the first problem comprises at least one of: an optimization problem or an inverse problem; processing, by the computing system, the declarative object-oriented definition of the HPES to generate a data structure representing relationships and interactions between the one or more subsystems and/or the one or more components of the HPES; transpiling, by the computing system, a first optimized code using the data structure, the declarative object-oriented definition and the definition of the first problem; and generating, by the computing system, a solution to the first problem by executing the first optimized code.

This application claims the benefit of U.S. Patent Application 63/654,799, filed May 31, 2024, which is incorporated by reference herein in its entirety.

### TECHNICAL FIELD

This disclosure is related to simulation systems, and more specifically to defining hierarchical engineering systems.

### BACKGROUND

The current landscape of Commercial Off-The-Shelf (COTS) and open-source packages often presents significant hurdles for engineering users due to a variety of issues. In many applications, these packages are typically designed by software developers and computational scientists, whose priorities in language and syntax may differ significantly from the priorities of engineers. This may lead to a steeper learning curve and may make the code feel less intuitive for someone with a strong engineering background but perhaps less specialized programming expertise. While users may often copy and paste snippets of code, truly elegant and modular reuse across different projects or even within the same project may be difficult.

The internal structures and data representations of the COTS packages may not align well. Vendor and package lock-in may create additional difficulties. The investment in learning a specific package and developing code within its ecosystem may become a barrier to trying alternative tools or integrating solutions across different software environments. If a user wants to switch packages or combine functionalities, users often may have to start from scratch, which may be inefficient and time-consuming. Software developers prioritize generality, performance within their specific framework, and adherence to software engineering principles. Engineers, on the other hand, often prioritize physical interpretability, ease of integration with their domain knowledge, and a workflow that mirrors engineering intuition.

Many COTS packages may focus on providing efficient implementations of specific numerical algorithms (e.g., optimization routines, solvers for differential equations). The user interface and the way these algorithms interact with the specific structure of a Hierarchical Physical and/or Engineering System (HPES) may be a secondary consideration. For example, COTS packages often lack high-level abstractions that directly map to the concepts and structures inherent in a HPES. Engineers may then be forced to translate their understanding of the system into the generic data structures and function calls of the package.

### SUMMARY

This disclosure describes techniques for mathematically describing the behavior of a
hierarchical physical and/or engineering system (HPES) using a simple, declarative object-oriented structure. The disclosed system may be built for engineers, having a syntax and conceptual framework that aligns with engineering thinking rather than pure software development. The HPES mathematically described using the disclosed system may be anything from complex mechanical assemblies to chemical processing plants, multi-scale material models, or even organizational structures within an engineering project.

For example, the techniques of this disclosure may be applied in the context of object-oriented declarative code. The object-oriented declarative code may allow engineers to model the HPES by defining classes that represent physical components or subsystems, encapsulating properties (attributes) and behaviors (methods) of the HPES. In other words, this may promote modularity and a natural mapping to the physical world. In contrast with conventional systems, instead of writing imperative code that explicitly steps through the solution process, users may use techniques of this disclosure to declare what the HPES is (e.g., structure, components, and relationships between the components) and what users want to achieve (e.g., define an inverse problem). The disclosed system may automatically handle the underlying execution details. In this way, the disclosed techniques may significantly reduce the cognitive load on the engineer. The disclosed system may use contemporary programming paradigms and may be implemented in modern programming languages, such as, but not limited to, Python programming language.

Because the HPES may be defined declaratively, the underlying model of the physical system may remain consistent. In general, to solve a different inverse problem (e.g., identify a different set of unknown parameters or optimize for a different objective), the engineer may reuse the existing HPES definition and may simply specify the new inverse problem formulation. This may avoid rewriting the system model from scratch.

In one example, the disclosed system may act as an abstraction layer. By processing the HPES definition at runtime, the disclosed system may interface with different backend solvers—potentially COTS software or open-source packages—without the user needing to rewrite the HPES definition for each backend. In general, this may provide flexibility and may allow users to leverage various tools for a particular problem. One important capability of the disclosed system is the ability to take the declarative HPES definition of the user and process that definition at runtime. In other words, the disclosed system may not be statically compiled. Instead, the disclosed system may dynamically interpret the definition and may create (instantiate) the corresponding HPES classes and the class attributes. This runtime processing may allow for a high degree of flexibility and adaptability.

Additionally, HPESs are often complex and composed of interconnected subsystems. The disclosed system may be designed to track the hierarchical dependencies within the defined system. Consequently, the disclosed techniques may be important for understanding how the behavior of one component or subsystem affects others.

In addition to the above technical advantages, the techniques may provide one or more other technical advantages that realize at least one practical application. As discussed above, declarative, object-oriented techniques of the disclosed system may dramatically reduce the complexity involved in defining and handling inverse problems. Instead of analyzing, writing, and revising intricate procedural code for each specific problem, engineers may leverage the existing HPES definition.

In an example, a method for solving problems involving a Hierarchical Physical and/or Engineering System (HPES) includes: receiving, by a computing system, a declarative object-oriented definition of the HPES having one or more sub-systems and/or one or more components; receiving, by the computing system, a definition of a first problem to be solved, wherein the first problem comprises at least one of: an optimization problem or an inverse problem; processing, by the computing system, the declarative object-oriented definition of the HPES to generate a data structure representing relationships and interactions between the one or more subsystems and/or the one or more components of the HPES; transpiling, by the computing system, a first optimized code using the data structure, the declarative object-oriented definition and the definition of the first problem; and generating, by the computing system, a solution to the first problem by executing the first optimized code.

In an example, a system for solving problems involving a Hierarchical Physical and/or Engineering System (HPES) includes: processing circuitry in communication with storage media, the processing circuitry configured to execute a machine learning system, the machine learning system configured to: receive a declarative object-oriented definition of the HPES having one or more sub-systems and/or one or more components; receive a definition of a first problem to be solved, wherein the first problem comprises at least one of: an optimization problem or an inverse problem; process the declarative object-oriented definition of the HPES to generate a data structure representing relationships and interactions between the one or more subsystems and/or the one or more components of the HPES; transpile a first optimized code using the data structure, the declarative object-oriented definition and the definition of the first problem; and generate a solution to the first problem by executing the first optimized code.

In an example, non-transitory computer-readable storage media having instructions encoded thereon for solving problems involving a Hierarchical Physical and/or Engineering System (HPES), the instructions configured to cause processing circuitry to: receive a declarative object-oriented definition of the HPES having one or more sub-systems and/or one or more components; receive a definition of a first problem to be solved, wherein the first problem comprises at least one of: an optimization problem or an inverse problem; process the declarative object-oriented definition of the HPES to generate a data structure representing relationships and interactions between the one or more subsystems and/or the one or more components of the HPES; transpile a first optimized code using the data structure, the declarative object-oriented definition and the definition of the first problem; and generate a solution to the first problem by executing the first optimized code.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a schematic, partial illustration of an example simulation environment in accordance with one or more techniques of the disclosure.

FIG. 2 is a detailed block diagram illustrating an example computing system, in accordance with one or more techniques of the disclosure.

FIG. 3 is a diagram illustrating an example workflow of a simulation system, in accordance with one or more techniques of this disclosure.

FIG. 4 illustrates a functional dependency diagram of an example HPES, in accordance with one or more techniques of the disclosure.

FIG. 5 illustrates an example of the Design Specific Language (DSL) code defining components of the HPES, in accordance with one or more techniques of the disclosure.

FIG. 6 illustrates an example of the DSL code that may be generated based on a system diagram, in accordance with one or more techniques of the disclosure.

FIG. 7 illustrates an example of the inverse problem code, in accordance with one or more techniques of the disclosure.

FIG. 8 is a flowchart illustrating an example mode of operation for a simulation system, according to one or more techniques described in this disclosure.

Like reference characters refer to like elements throughout the figures and description.

### DETAILED DESCRIPTION

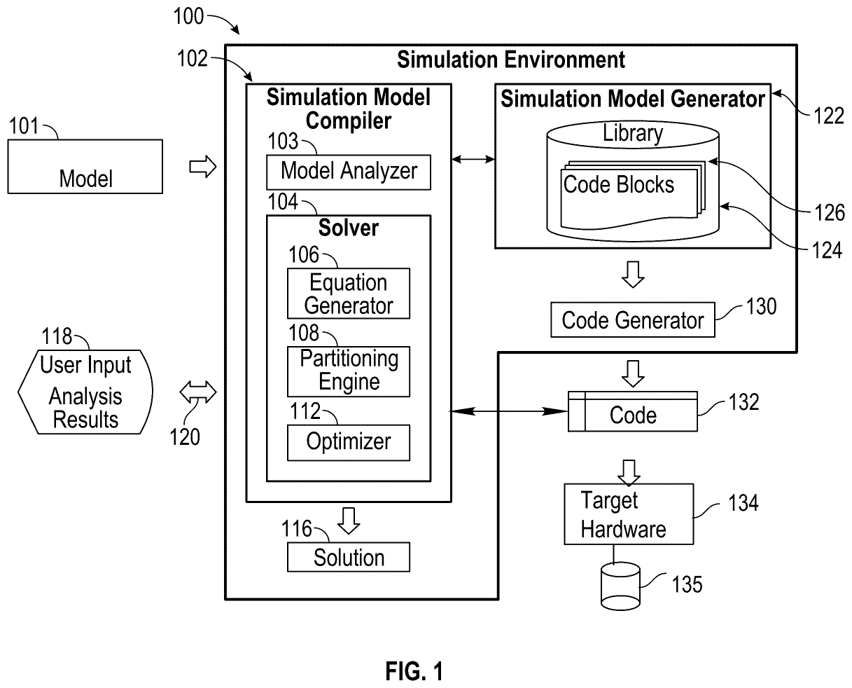

FIG. 1 is a schematic, partial illustration of an example simulation environment in accordance with one or more techniques of the disclosure. To develop a real-world hierarchical physical and/or engineering system (HPES), a user may follow a model-based design approach in which a model may be created within a computer-based simulation environment.

An HPES is a system that is organized into multiple levels, where each level is composed of subsystems or components that serve specific roles and collectively contribute to the function of the overall system. The term “hierarchical” implies that these subsystems are nested or structured in a top-down or bottom-up manner, with higher levels governing broader or more abstract functions, and lower levels handling more detailed, concrete tasks. Example HPESes include vehicles, airplanes, plants/factories, industrial robots, a smart phone, the power grid, a skyscraper, and others.

Modeling an HPES thus involves modeling a complex, multi-level structure in which interdependent subsystems/components operate across different physical domains, time scales, and abstraction layers. Each subsystem/component may operate according to a different set of dynamic equations, constraints, and performance criteria, and must coordinate with subsystems/components in the hierarchy to achieve overall objectives for the HPES. This complexity is compounded by heterogeneous modeling formalisms (e.g., mechanical, electrical, and computational dynamics), nonlinear and possibly stochastic behavior, and the need to manage both local and global constraints.

The model may be executable, and may be designed to simulate the behavior or operation of the HPES being developed. The simulation environment 100 may include a simulation model compiler 102, which in turn may include a model analyzer 103 and a solver 104. The solver 104 may include an equation generator 106, a partitioning engine 108, and an optimizer 112. The simulation model compiler 102 may access or receive a model 101, and the solver 104 may generate a solution, indicated at 116, for simulating the model 101.

For example, the equation generator 106 may generate a system of equations for the model 101. The partitioning engine 108 may transform at least some of the equations into groups of equations, e.g., partitions, whose inputs/outputs are connected directly. In some cases, the partitioning engine 108 may automatically partition a user-defined Design of Experiments (DOE) into a configurable set of databases (DBs) 135 that may be processed in parallel, as described below.

The solver 104 may determine an order of execution of the groups of equations. The order may be based on the equations' computation and use of variables such that values for variables are computed by and passed to equations in a combination of cascading and parallel execution units. In some embodiments, the solver 104 may construct a directed acyclic graph that expresses the order of execution. Nodes of the graph may represent the equations and/or the groups of equations. The solution 116 may be machine instructions suitable for real-time execution by the simulation environment 100.

In some aspects, the simulation model compiler 102 may present results of its analysis or processing of the model 101, e.g., to a user, during the generation of the solution 116. The simulation model compiler 102 also may receive input and/or feedback from the user to guide its generation of the solution 116, as indicated by input parameters 118 received by a display device and arrow 120.

For example, the solver 104 may be configured to generate a family of solutions for the model 101. The solver 104 may utilize the user input, which may concern desired accuracy, stability, and robustness, and the manner of eliminating or avoiding algebraic loops, to produce the specific solution 116. The environment 100 may further include a simulation model generator 122 that may include or have access to memory, such as one or more libraries, indicated at 124. The libraries 124 may include code blocks 126, e.g., blocks, that are supported by the simulation environment 100.

In some aspects, a family of simulation models, for example corresponding to the family of solutions generated by the solver 104, may be presented to the user at the display device 118. The user input and/or feedback may include selection of one or more models from the family of models.

In some aspects, the simulation environment 100 may include or be accessible by a code generator 130. The code generator 130 may generate code, indicated at 132, based on the specific solution 116. The generated code 132 may be executable outside of the simulation environment 100. For example, the code 132 may be source code, e.g., Python code, C code, C++ code, etc., and the source code may be compiled into an executable, such as object code. In an aspect, the code 132 may be the code to solve an inverse problem in a specific custom-built solver.

In some examples, the simulation model compiler 102 may further receive or have access to target hardware characteristics and/or attributes for the target hardware 134. Exemplary characteristics and/or attributes include processor speed, number of processing cores for a multi-core CPU, clock rate and number and type of hardware elements for an FPGA, etc. The optimizer 112 may guide the generation of the specific solution 116 so that the solution 116 will be optimized. In an aspect, the generated code 132 may be fed into the optimizer 112 to be evaluated to find solution 116. The optimizer 112 may apply one or more rules for optimizing the code generated for the specific target hardware 134.

One or more of the solver 104, the simulation model generator 122, and the code generator 130 and/or one or more of the parts thereof may be implemented through one or more software modules or libraries containing program instructions that perform the methods described herein, among other methods. The software modules may be stored in one or more memories, such as a main memory, a persistent memory and/or a computer readable media, of a workstation, server, or other data processing machine or device, and executed by one or more processors. Other computer readable media may also be used to store and execute these program instructions, such as non-transitory computer readable media, including optical, magnetic, or magneto-optical media. In other embodiments, one or more of the solver 104, the simulation model generator 122, and the code generator 130 may themselves be implemented in hardware, such as hardware registers and combinational logic configured and arranged to produce sequential logic circuits. In alternative embodiments, various combinations of software and hardware, including firmware, may be utilized to implement the described methods. The simulation environment 100 may receive and/or access the model 101. In some aspect, the model 101 may be a physical component model.

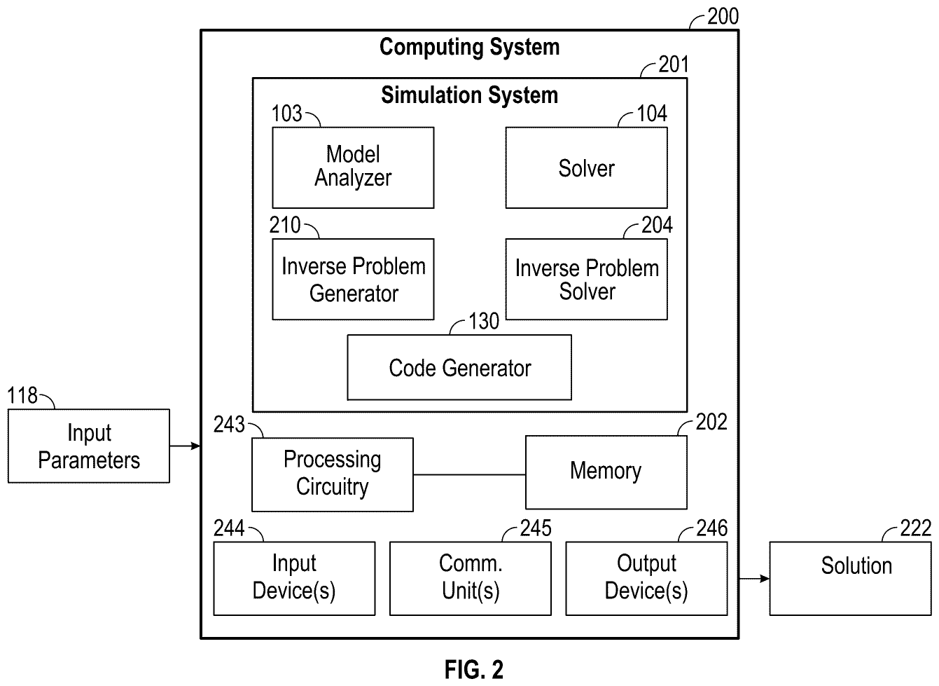

FIG. 2 is a block diagram illustrating an example computing system 200. In an aspect, computing system 200 may comprise an instance of the simulation environment 100. To simulate a physical system, as shown, computing system 200 includes processing circuitry 243 and memory 202 for executing simulation system 201 having model analyzer 103, solver 104, inverse problem solver 204, inverse problem generator 210 and code generator 130.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. Computing system 200 may represent an instance of simulation environment 100 of FIG. 1.

In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., model analyzer 103, solver 104, inverse problem solver 204, inverse problem generator 210 and code generator 130), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute computing system 100 using virtualization modules, such as a virtual machine or container executing on underlying hardware. One or more of such modules may execute as one or more services of an operating system or computing platform. Aspects of computing system 100 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

In the example of FIG. 2, model analyzer 103 may receive input data and solver 104 and/or inverse problem solver 204 may generate output data. The input data and the output data may contain various types of information. For example, the input data may include (input parameters 118 as well as a description of the physical system being simulated). The output data may include solution 222 as well as values of the output variables.

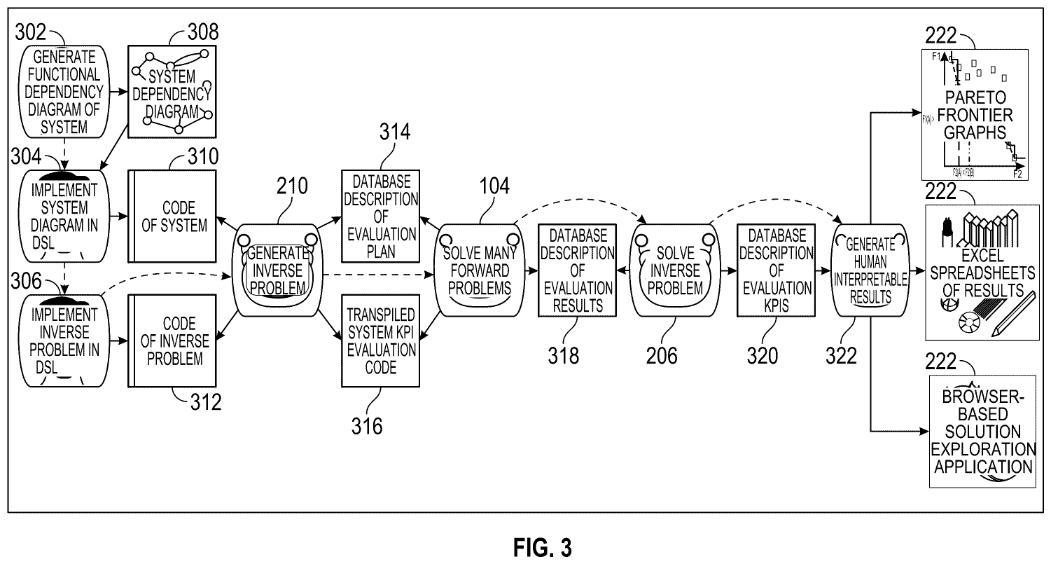

FIG. 3 is a diagram illustrating an example workflow of a simulation system, in accordance with one or more techniques of this disclosure. More specifically, FIG. 3 illustrates simulation system 201 that may be used as a tool that may help engineers build a digital twin of their physical or engineering system (referred to hereinafter as a “physical system”). Instead of just drawing diagrams or writing disconnected code snippets, simulation system 201 may provide a structured way to represent the components of the physical system and interactions between these components mathematically. Many real-world physical systems may be complex and may include smaller, interconnected subsystems. Simulation system 201 may allow engineers and/or scientists to mirror this structure of the physical system in generated code 132, which may improve readability, understanding and management of the generated code 132. As a non-limiting example, a car may be viewed as a system composed of subsystems such as, but not limited to, the engine, transmission, braking system, etc., each subsystem having its own components. Simulation system 201 may help represent the aforementioned hierarchy. Simple, declarative object-oriented structure of the simulation system 201 may be important for re-usability and modularity.

Instead of writing lengthy, procedural code, users may define the physical system using clear, object-oriented principles. Users may declare what the components are and how these components relate to each other, and simulation system 201 may take care of the underlying mathematical representation.

In some examples, simulation system 201 may receive code or the definition and may turn the definition into code using schema and a Large Language Model (LLM). A schema (e.g., JSON Schema, XML Schema, database schema) may define the structure and rules for the declarative definition. Such schema may be like a blueprint for the input data. Such schema may better ensure that the received declarative definition is syntactically correct and adheres to the expected structure. The LLM may be the generative AI component that may transform the high-level declarative definition into low-level, executable code. The declarative definition (e.g., YAML/JSON) may be fed to the LLM as part of an engineered prompt. The prompt may also include the schema for the target code (e.g., Python classes, C++ structs) that the LLM should generate. This schema may specify to the LLM what kind of code structure the LLM needs to generate.

These technique may make generated code 132 more readable and maintainable. When simulation system 201 encounters input files (e.g., Python files) files defining the physical system, the simulation system 201 may not just load the code; model analyzer 103 component of the simulation system 201 may analyze the input files to understand the structure and relationships defined in the input files. Simulation system 201 may essentially build an internal mathematical model of the physical system as a graph, for example.

This internal representation of instanced user-defined classes as a graph may be powerful. Each component of the physical system may become a node in the graph, and the connections between the components may represent dependencies (e.g., the output of one component is the input of another). This graphical representation may allow for sophisticated analysis. One of the key features of simulation system 201 may be the ability to automatically add extra properties and data to the user defined classes behind the scenes.

According to aspects of the disclosure, this instrumentation may provide the necessary information for the subsequent steps, like exploring dependencies and transpilation. That is, in this case, there may be no need for users to manually add a lot of boilerplate code. However, once the physical system is represented as a graph, simulation system 201 may allow users to easily understand how different parts of the physical system influence each other. For example, users may programmatically query these dependencies or may review the dependencies of the physical system represented as a graph, which may be helpful for debugging, understanding behavior of the physical system, and for identifying potential bottlenecks. These techniques may be useful for transpiling the system code into efficient evaluation code, which may improve performance of simulation system 201. The declarative code written by users, which may be part of model 101, for example, may not be the most efficient for direct execution, especially for complex mathematical models. In an example, optimizer module 112 of the simulation system 201 may take high-level description code provided by users as input files and may translate that code into optimized code 132 that runs faster, potentially leveraging techniques like symbolic computation or numerical optimization.

By having a mathematical description of the physical system built from interconnected classes, simulation system 201 may provide the necessary foundation to systematically explore how changes in the independent variables (IVs) affect the behavior of the physical system. Because simulation system 201 defines the physical system as a set of classes with mathematical relationships, identifying the parameters users want to vary (the independent variables) may become relatively straightforward. These IVs may be properties of the individual classes within simulation system 201.

The simulation system 201 may allow users to explicitly declare these IVs as mathematical symbols within the definition of each class, in accordance with techniques described herein. Such declaration may clarify which parameters may be manipulated for the Design of Experiments (DOE) simulations. The ability to associate units and dimensions with IVs may be an important advantage for DOE. Specification of units and dimensions may better ensure that experimental design of users is physically meaningful and that users are exploring the parameter space in a consistent way.

Support for units and dimensions may help simulation system 201 prevent errors that may arise from inconsistent scaling or incompatible units during the experimental runs (simulations). Once the IVs are defined, simulation system 201 may be used to generate the experimental design matrix.

The aforementioned experimental design matrix may specify the different combinations of the IV values that may be tested. Because simulation system 201 understands the interconnectedness of the physical system, the simulation system 201 may help users run these experiments/simulations efficiently. In other words, for each set of IV values in a particular design matrix, simulation system 201 may execute the mathematical model of the physical system to predict the resulting outputs (e.g., dependent variables). The ability to transpile the system code into efficient evaluation code may become particularly valuable during DOE.

For example, running multiple simulations with different IV combinations may be computationally intensive. Essentially, transpilation capabilities of the simulation system 201 may better ensure that each simulation runs as quickly as possible.

In an aspect, the transpilation to, for example, standard Python code may allow users to seamlessly integrate simulation system 201 with various DOE and statistical analysis libraries available in Python (e.g., scikit-learn, statsmodels, pyDOE2, etc.). Integration of such tools may help simulation system 201 generate different types of experimental designs (factorial, response surface, etc.). In a non-limiting example, simulation system 201 may also use such tools to analyze the results of simulations to better understand the main effects, interactions, and quadratic effects of IVs specified by the user on the outputs of the physical system.

In an aspect, simulation system 201 may build statistical models of behavior of the physical system based on the simulation data. Simulation system 201 may identify optimal operating conditions or design parameters. Simulation system 201 may provide a structured way to define the physical system and parameters of the physical system (e.g., input parameters 118). Simulation system 201 may allow clear identification and specification of the independent variables, including units and dimensions of the IVs. In other words, simulation system 201 may enable efficient execution of multiple experimental runs/simulations through its transpilation capabilities.

Simulation system 201 may allow users to define the fundamental IVs for each custom class. These IVs may be viewed as the “ingredients” or the adjustable knobs that may influence the behavior of a particular class.

Simulation system 201 may assign symbolic names to these IVs (e.g., Temperature, Pressure, FlowRate). These symbols may then be used by the simulation system 201 in subsequent mathematical expressions.

Users may specify a starting or typical value for each IV. This default value may be useful for initialization and may represent a common operating condition. Users may also set upper and lower bounds for the permissible values of an IV. This valid range may help in better ensuring that the inputs to a class defined by a user may remain physically meaningful or within the operational limits defined by the user.

As yet another example, simulation system 201 may then use these ranges for validation or optimization purposes.

In an aspect, users may define the data type of the IV. In an aspect, users may define the data type to be float/real for continuous numerical values (e.g., temperature, pressure). As an example, users may define the integer data type for discrete whole numbers (e.g., number of stages, number of components).

Users may define the categorical data type for variables that may take on a limited set of predefined text values (e.g., solvent type, reactor type). As yet another example, users may further restrict this categorical data type to “real” if users are dealing with a specific set of real-world categories. In other words, “other” data types may encompass more complex or user-defined categorical types. In essence, this feature may allow users to clearly define the inputs that may govern the state and behavior of the custom class of the user, along with important constraints and characteristics of those inputs.

The dependent variables (DVs) may represent the outputs or the calculated properties of the custom class defined by the user. The values of dependent variables may depend on the values of the independent variables and potentially other dependent variables.

In general, just like IVs, users may assign symbolic names to the DVs (e.g., OutletTemperature, Conversion, ProductYield). Simulation system 201 may use mathematical expressions to define the relationships between the DVs and the IVs (and potentially other DVs). Users may use mathematical equations and operators to express how the DVs may be calculated based on the current values of the IVs and other relevant variables.

According to the disclosed techniques, these mathematical expressions may include, but are not limited to: basic arithmetic operations (+, −, *, /), mathematical functions (e.g., sin, cos, exp, log), conditional logic (e.g., if-then-else statements) and references to other IVs and DVs within the same class. According to the disclosed techniques, this step may be important because this step may define the functionality and the outputs of a custom class defined by a user based on inputs and internal relationships of that class. Generally, this step may allow users to model complex behavior of a physical system using mathematical equations.

Overall, the HPES in simulation system 201 may provide a flexible and modular way to structure process models, allowing users to represent complex physical systems as interconnected units. In this case, the top-level system may contain an arbitrary number of containers of an arbitrary number of sub-systems. In other words, main process flow sheet defined by a user may be organized into logical groupings (containers), and each of these containers may hold multiple individual unit operations or sub-models (sub-systems). This top-level system may allow for a hierarchical organization of the entire process defined by the user. Sub-systems may contain an arbitrary number of containers of an arbitrary number of sub-systems. This highlights, for example, the recursive nature of the HPES. In other words, users may nest sub-systems within containers within other sub-systems, creating multiple levels of hierarchy. In addition, this hierarchy may be powerful for breaking down complex processes into manageable and reusable modules. For example, a reactor sub-system may contain a mixing container with a stirrer sub-system and a reaction zone sub-system.

Essentially, the HPES may offer unlimited levels of nesting, enabling users to represent any process at varying levels of detail and organization. For example, Independent Design Variables (IDVs) may be identified, generally, or at the time of optimization, as being equivalent to other IDVs.

In accordance with the techniques of the present disclosure, equivalence of IDVs may be an important feature for establishing relationships and constraints within user's model. In other words, users may define that certain IVs in different parts of the HPES are inherently linked. For example, the outlet temperature of one unit may be defined as being equal to the inlet temperature of the next unit. This general equivalency may better ensure consistency and may reduce the number of truly independent variables. During optimization studies, users may want to temporarily link certain IVs to explore specific operating scenarios or to reduce the dimensionality of the optimization problem. Simulation system 201 may allow users to define these equivalences specifically for the optimization run. This equivalence of IDVs capability may allow for flexible control over the degrees of freedom in the physical model being evaluated by the user and may enable users to enforce physical constraints or explore specific operating strategies. In other words, as the HPES hierarchy is not necessarily directed or acyclic, simulation system 201 may enable DVs to depend on IDVs and DVs in any sub-system within the HPES. In an aspect, the relationships between units in the HPES may not necessarily flow in a single direction. In one non-limiting example, information may be exchanged bidirectionally between connected units.

In an example, simulation system 201 may handle scenarios where information flow creates loops. For example, the recycle stream in a process may create a cyclic dependency. It should be noted that the conditions of the recycle stream (a set of DVs of the recycle unit) may depend on the conditions of the downstream unit, which in turn may depend on the inlet conditions that include the recycle stream. In other words, a DV in one sub-system may be defined as a function of an IV or a DV in a completely different sub-system, regardless of their hierarchical relationship.

In addition, DV dependencies across subsystems may allow for complex interactions and feedback loops to be modeled accurately. This flexibility may be important for representing real-world processes where interdependencies and recycles are common. In an example, the simulation engine of simulation system 201 (e.g., solver 104) may be configured to handle these complex information flows and may converge to a consistent solution. In one possible implementation, partitioning engine 108 of the simulation system 201 may automatically partition a user-defined DOE into a configurable set of databases (DBs) 135 that may be processed in parallel. When users run a Design of Experiments to study the impact of various input parameters on the process outputs, simulation system 201 may significantly speed up the calculations by dividing the simulation cases into multiple databases 135 and may process these cases simultaneously on multi-core processors or distributed computing environments. In most cases, the number of parallel databases 135 may be configurable by the user to optimize resource utilization.

For example, when users define a DOE in the simulation system 201, these users may essentially instruct the software to run multiple simulations while systematically varying certain input parameters 118. To speed this up, simulation system 201 may divide these individual simulation runs into several independent databases 135 that may be processed concurrently. The following describes how simulation system 201 may interpret DOE of the user and how the simulation system 201 may organize the DOE for parallel processing. Initially, model analyzer 103 may read and understand the parameters defined by the user for the DOE. In other words, this step may involve dissecting the following components, including, but not limited to: objectives, constraints, IDVs, Independent Control Variables (ICVs), Categorical Variables (CVs) and other Key Performance Indicators (KPIs). For example, the objectives may be the target output variables simulation system 201 may need to optimize or study.

In an example, users may want to maximize product yield, minimize energy consumption, or achieve a specific product purity. For example, model analyzer 103 may identify these objectives, which may be evaluated for each simulation run in the DOE. The term “constraint(s),” as used herein refers to the limitations or boundaries that the physical system should adhere to. In other words, users may have constraints on operating temperature, pressure limits, or product specifications. Additionally, simulation system 201 may check if these constraints are satisfied for each simulation run. In other words, runs that violate constraints may be flagged or excluded from the analysis, depending on particular DOE settings. The IDVs may be the input parameters 118 that users may want to systematically vary to observe the impact of these parameters on the objectives and constraints. For each IDV, users may specify bounds and evaluation levels. In an aspect, the bounds may include the minimum and maximum allowable values for each IDV. In an example, simulation system 201 may better ensure that the generated values for these variables stay within these defined limits. The evaluation levels may define the specific values or steps at which each IDV will be evaluated. Therefore, for a continuous IDV, users may specify a range and a number of levels (e.g., Temperature from 100° C. to 200° C. at 3 levels: 100, 150, 200).

For a discrete IDV, users may list the specific values to be tested (e.g., Reactor Type: Plug Flow, Continuous Stirred Tank). The combination of these levels across all IDVs may determine the total number of simulation runs in the full factorial DOE. It should be noted that Independent Control Variables (ICVs) may be the input variables that users may want to vary during the DOE but may typically keep constant within a single simulation run.

In an aspect, ICVs may be used to represent operating conditions or equipment settings that may be adjusted. The levels for ICVs may define the different settings users may want to explore across the DOE runs. The Categorical Variables (CVs) may be the discrete input variables that represent distinct categories or choices (e.g., different catalysts, different solvents, different equipment configurations). Advantageously, the levels for CVs may be the different categories users may want to evaluate in their DOE. Simulation system 201 may run simulations for each combination of the specified categories with the levels of the continuous IDVs and ICVs.

According to one or more disclosed techniques, once model analyzer 103 has interpreted the DOE setup, the simulation system 201 may determine the total number of simulation runs required (based on the number of levels for each IDV, ICV, and the number of categories for each CV). To enable parallel processing, partitioning engine 108 may then divide these individual simulation cases into a configurable number of databases 135. In one example, users may specify how many databases 135 simulation system 201 should create.

The configurable number of databases 135 may allow users to control the degree of parallelism based on the number of available processor cores. Furthermore, partitioning engine 108 may intelligently distribute the simulation cases across these databases 135. According to the disclosed techniques, the goal may be to have roughly an equal number of simulation runs in each database 135 to ensure balanced workload distribution among the parallel processing units. With the DOE cases distributed across multiple databases 135, simulation system 201 may then launch multiple instances of its simulation engine (or threads), such as solver 104, to process these databases 135 concurrently. Each database 135 may be essentially an independent set of simulation runs. The simulations within different databases 135 may run in parallel, significantly reducing the total time required to complete the entire DOE compared to running the simulations sequentially.

Beyond the primary objectives and constraints, users may define other KPIs to track and analyze as part of the DOE. These KPIs may include, but are not limited to, utility consumption, byproduct formation, or specific equipment loads. Simulation system 201 may interpret these KPIs as additional output variables to be calculated and stored for each simulation run.

In an aspect, simulation system 201 may analyze the mathematical expressions users defined for their objectives and constraints (and implicitly for the KPIs). The simulation system 201 may identify which IDVs and ICVs directly or indirectly influence each of these output variables. According to the disclosed techniques, this analysis may result in a dependency graph, illustrating the flow of calculations.

In an example, based on the dependency graph, simulation system 201 may not just run the solver 104 repeatedly. Instead, in an aspect, simulation system 201 may generate highly efficient, often vectorized, code (e.g., optimized mathematical functions) specifically designed to calculate the objectives, constraints, and KPIs directly from the current values of the IDVs and ICVs. Vectorization may allow for performing the same calculation on multiple data points (multiple DOE runs) simultaneously, which may be important for efficient parallel processing.

In one example, this step may be an important optimization. Instead of running full process simulations for every DOE point, optimizer 112 may create streamlined calculation routines, significantly speeding up the evaluation. As discussed above, partitioning engine 108 may divide the total set of DOE simulation cases (each case being a unique combination of the levels of users IDVs and ICVs, and the categories of users CVs) into a configurable number of databases 135, Each database 135 may hold a subset of these distinct combinations or “records.” For each database 135, the simulation system 201 may take the sets of IDV and ICV combinations and may apply the pre-compiled, vectorized code to calculate the values of all defined constraints for every record within that database 135. This may happen concurrently across all the databases 135, leveraging parallel processing. Once the constraint evaluations are complete for all databases 135, the results may be aggregated or joined together into a unified dataset by partitioning engine 108.

In one example, this dataset may contain the values of all constraints for every simulation run in the DOE. For each database 135, the simulation system 201 may examine the calculated constraint values.

Based on the defined constraint conditions (e.g., “must be less than or equal to”), any simulation run (record) within that database 135 that violates one or more constraints may be either removed (dropped) from the dataset or marked (masked) as infeasible. This parallel filtering may better ensure that subsequent analysis focuses only on the valid or feasible operating regions defined by user's constraints. In most cases, simulation system 201 should have a thorough understanding of the DOE setup, including, but not limited to, objectives, constraints, IDVs, ICVs, and other KPIs.

Once optimizer 112 completes an important optimization step, code generator 130 may generate efficient, vectorized calculation code for the output variables based on their dependencies on the input variables. In an aspect, partitioning engine 108 may distribute the numerous DOE simulation cases across multiple databases 135 for parallel evaluation. In one example, simulation system 201 may perform the computationally intensive task of evaluating constraints in parallel for each database 135 using the generated code 132.

More specifically, similar to how constraints are handled, simulation system 201 may take the sets of IDV and ICV combinations within each database and may apply the pre-compiled, vectorized code to calculate the values of all defined objective functions for every feasible record (those that passed the constraint checks) within that database 135. This computation may happen concurrently across all the databases 135. Once the objective evaluations are complete for all databases 135, the results may be aggregated or joined together by partitioning engine 108 into the unified dataset containing the objective values and/or KPI values for all feasible simulation runs. In the context of consolidating results, the records that were masked due to constraint violations may be excluded from this final joined dataset.

In an aspect, solver 104 may identify the record(s) that yield the best value for the single objective function (either the minimum or maximum, as users specified in the DOE setup). Solver 104 may then either remove (drop) or mask all other records that do not achieve this optimal value, potentially considering a user-defined tolerance or range around the optimum.

For example, this masking may help to focus on the most promising operating conditions. When dealing with multiple conflicting objectives, there may not be a single “best” solution.

Advantageously, instead of a single solution, the concept of the Pareto frontier may come into play. In other words, a Pareto frontier may represent a set of solutions where improving one objective would necessarily worsen at least one other objective. In one example, solver 104 may compute this n-dimensional Pareto frontier based on the objective values of all the feasible simulation runs. In this context, solver 104 may then drop or mask all the records that are dominated by at least one point on the Pareto frontier (meaning there exists another solution that is better or equal in all objectives and strictly better in at least one).

It should be noted that in this example, the remaining records may constitute the Pareto-optimal set. Importantly, in an example, simulation system 201 may automatically generate a browser-based website or user interface that may allow users to interactively visualize this Pareto frontier. This UI may enable users to explore the trade-offs between the different objectives and select a solution that best meets specific needs and priorities of these users. Users may utilize the UI to filter, zoom, and/or examine the objective values for each point on the frontier.

In one possible implementation, this UI may allow users to: visualize the dependency graph discussed above, showing how different variables influence each other. The UI may allow users to examine the simulation results in various formats (tables, plots, charts). For example, simulation system 201 may investigate the sensitivity of objectives and KPIs to changes in IDVs and ICVs. The UI may filter and sort the results based on different criteria.

In one example, a Python API of the simulation system 201 may allow users to interact with the hierarchical components, including HPES and its sub-elements, in a “live” manner using symbol handles for direct access and manipulation. This interaction may facilitate debugging through real-time inspection and may enable the creation of automated unit tests for specific parts of the complex physical model.

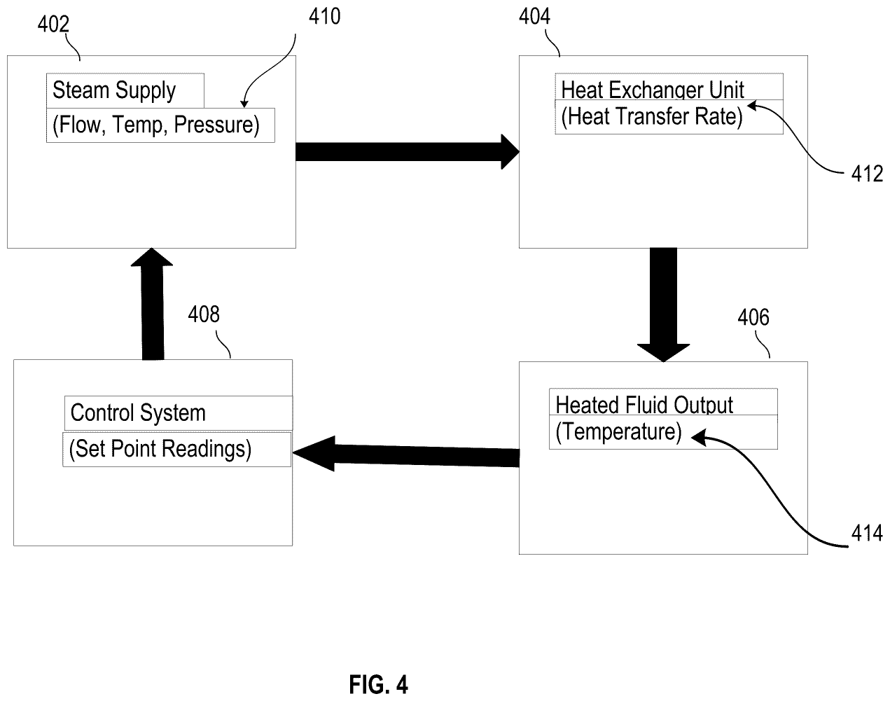

Referring back to FIG. 3, different components illustrated in FIG. 3 will be described below using an illustrative example of an HPES system shown in FIG. 4. In this example, the HPES system may comprise a simplified Heat Exchanger System for heating a fluid using steam. In this example, the hierarchy may include three levels.

In this example, the first level may be the overall heat exchanger system 400. It should be noted that in this example, the second level may include subsystems, such as, but not limited to, steam supply subsystem 402, heat exchanger unit 404, heated fluid output subsystem 406, and control system 408. Advantageously, the third level (not shown in FIG. 4) may include components (e.g., within the heat exchanger unit 404), which may include, but are not limited to, tubes, shell, inlet nozzle (fluid), outlet nozzle (fluid), inlet nozzle (steam), outlet nozzle (condensate).

FIG. 4 illustrates a functional dependency diagram of an example HPES, in accordance with one or more techniques of the disclosure. This diagram may be generated at 302 by model analyzer 103, for example, and may show the basic flow of influence within the HPES. The functional dependencies within the illustrated HPES are illustrated as arrows, indicating that one component or subsystem's output may influence another. More specifically, as shown in FIG. 4, the steam supply 402 and the incoming fluid properties 410 may determine the heat transfer rate 412 within the heat exchanger unit 404, which in turn may affect the outgoing fluid temperature 414 and the condensate of the heated fluid output 406. The control system 408 may adjust the steam supply 402 based on the measured outlet fluid temperature 414.

At 308, model analyzer 103, may generate a system dependency diagram based on the functional dependency diagram illustrated in FIG. 4. The system dependency diagram may focus on the relationships and interactions between the subsystems and components 402-408. The system dependency diagram may be more detailed than the functional dependency diagram illustrated in FIG. 4, potentially including physical connections and information flow. The system dependency diagram may highlight the physical connections and the role of the control system 408 in monitoring and manipulating the steam supply 402 based on the heated fluid output 406.

As noted above, the simulation system may employ a Design Specific Language (DSL). In one example, DSL may be employed by simulation model generator 122 shown in FIG. 1. In addition to DSL, simulation model generator 122 may employ library 124 of one or more code blocks 126 described below, such as, but not limited to, object-oriented declarative code. The object-oriented declarative code may allow engineers to model the HPES by defining classes that represent physical components or subsystems, encapsulating properties (attributes) and behaviors (methods) of the HPES. In other words, this may promote modularity and a natural mapping to the physical world. By contrast with conventional systems, instead of writing imperative code that explicitly steps through the solution process, users may use techniques of this disclosure to declare what the HPES is (e.g., structure, components, and relationships between the components) and what users want to achieve (e.g., define an inverse problem).

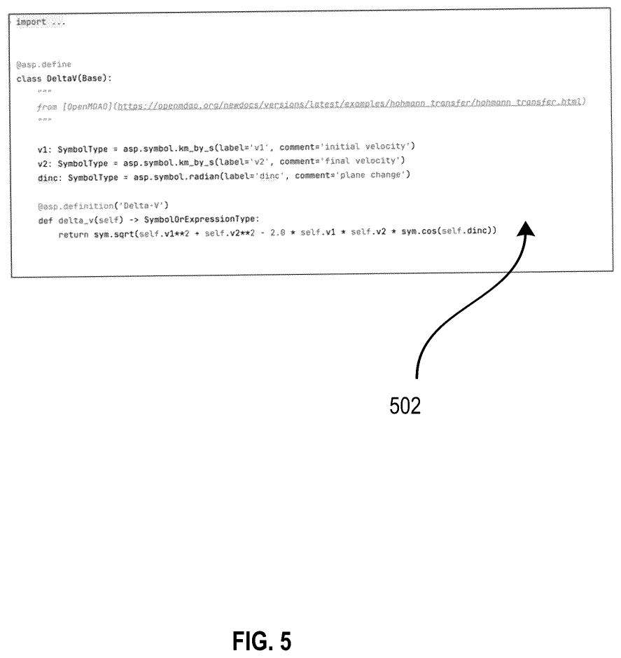

In some examples, one or more blocks (classes) may be defined representing the functional units. FIG. 5 includes definition 502 that illustrates an example of such classes.

As noted above, a real implementation may require more detailed modeling within each based on the specific models of the simulation system 201 and the level of fidelity required. Based on the conceptual DSL, generation of the actual code may involve using the graphical user interface (GUI) to build the flowsheet. In one example, a user may define a problem. Next, the user may define components (e.g., variables constraints and objectives).

Following is the example DSL code that may be used to solve a Hohmann transfer problem. The Hohmann transfer problem in astronautics deals with finding the most fuel-efficient (minimum delta-v) way to transfer a spacecraft between two co-planar circular orbits at different altitudes around a central body. The Hohmann transfer is generally the most fuel-efficient two-impulse maneuver between co-planar circular orbits because the velocity changes are applied tangentially to the orbits at the points where they intersect with the transfer ellipse. This ensures that the energy added or removed is used most effectively to change the orbit's size.

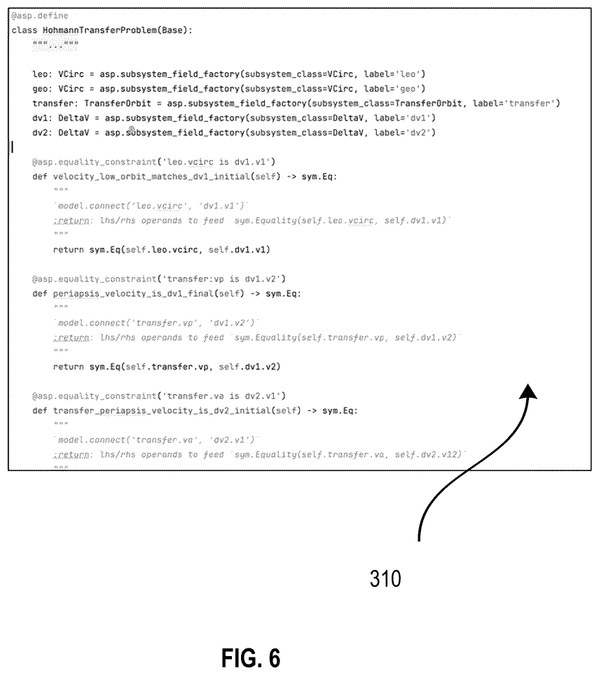

In this example, simulation system 201 may implement system diagram in DSL code 304, which may result in the code 310 shown in FIG. 6.

In some examples, one or more blocks (classes) may be defined representing the functional units. As noted above, FIG. 5 includes definition 502 that illustrates an example of such classes.

As shown in the definition 502, users may define one or more variables (e.g., initial velocity, final velocity, etc.). Defined variables may include, but are not limited to IDVs, ICVs, and CVs described above.

In some cases, simulation system 201 may be used to implement 306 and solve an inverse problem. Continuing with the Hohmann transfer problem example, in the standard (or forward) Hohmann transfer problem, the scenario the initial circular orbit, the desired final circular orbit and the properties of the central body (gravitational parameter u) may be given as input parameters 118 to the simulation system 201. The objective of the forward Hohmann transfer problem may be to determine the required delta-v magnitudes and the transfer time to move the spacecraft from the initial to the final orbit using a Hohmann transfer. An inverse problem, in contrast, may start with some of the results of the forward problem and may try to determine the inputs that led to those results. There can be several types of inverse problems related to the Hohmann transfer, depending on what information is given and what users want to find.

In one example of the inverse problem, the magnitudes of the two delta-v burns that were applied, the final circular orbit and the central body may be given. The objective of the inverse problem may be to determine the radius of the initial circular orbit. In this case, simulation system 201 would be working backward from the effects (the delta-v values and the resulting final orbit) to infer the initial conditions. This inverse problem might be relevant if users have telemetry data about the maneuvers performed and the final orbit achieved, but users may be unsure about the precise initial orbit before the transfer.

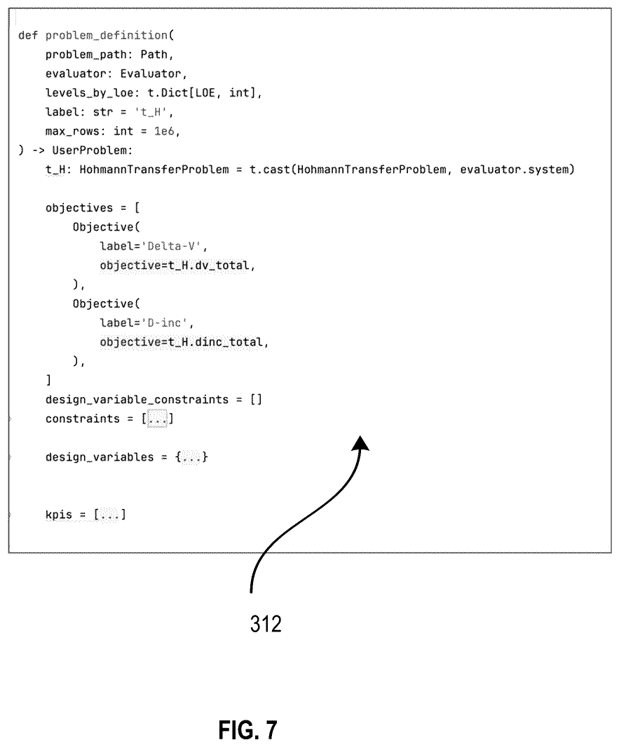

Accordingly, in this case, inverse problem generator 210 in conjunction with code generator 130 may use DSL code of inverse problem definition 306, as well as the system code 310 to generate inverse problem code 312. Example of the inverse problem code 312 in the context of the Hohmann transfer problem is shown in FIG. 7.

As shown in FIG. 7, users may define design variable, constraints, objectives and so on. In other words, this step may involve defining an objective function (e.g., Delta-V). In one example, the user may define the inverse problem by specifying the unknown parameters and the target values of the measured outputs using the design spec feature of the simulation system.

Users may define what they want to achieve with the inverse problem. More specifically, the objective of the inverse problem may be to find the values of the unknown parameters that make the simulated outputs match the observed measurements as closely as possible. As noted above, a user may select an appropriate technique to solve the inverse problem. For some complex problems, the simulation system 201 may employ optimizer 112 to find the best parameter values. In other words, if the physical system involves dynamic behavior and time-dependent data, the simulation system 201 may have optimization capabilities.

As shown in FIG. 3, at 314, simulation system 201 may generate an evaluation plan. In essence, the evaluation plan may provide the observed data for the specific inverse problem. Inverse problem solver 204 may use this data, along with the forward model (orbital mechanics), to infer the hidden causes or the extent to which different factors contributed to the observed outcome (the failed Hohmann transfer). An evaluation plan for an inverse problem solution may outline how users will assess the quality and reliability of the estimated parameters. A database description for such a plan may include the elements described below. For problem identification, the database may include the following fields: problem name, forward model, unknown parameters and measured data. The problem name may be a unique identifier for the specific inverse problem being evaluated. The forward model may be the description of the forward model used (e.g., mathematical equations). The unknown parameters field may include the list of the parameters being estimated in the inverse problem. The measured data may include a description of the experimental or operational data used for parameter estimation (e.g., type of measurement, number of data points, experimental conditions). Evaluation metrics may be stored as the following fields in the database: metric name, metric description, target value/range.

In an aspect, at 316 simulation system 201 may generate the transpiled system KPI evaluation code. As noted above, the ability to transpile the system code into efficient evaluation code may become particularly valuable during DOE. For example, running multiple simulations with different IV combinations may be computationally intensive. Essentially, transpilation capabilities of the simulation system 201 may better ensure that each simulation runs as quickly as possible. In an aspect, the transpilation to, for example, standard Python code may allow users to seamlessly integrate simulation system 201 with various DOE and statistical analysis libraries available in Python (e.g., scikit-learn, statsmodels, pyDOE2, etc.). In a non-limiting example, language-specific syntax and data structures may be adapted (e.g., def to function, list comprehensions to map, array handling). External libraries or built-in functions for statistical calculations (like percentile) may need to be replaced with equivalents or custom implementations in the target language. It should be noted that the actual transpilation process may involve a dedicated tool that understands the syntax and semantics of the source language and generates equivalent code in the target language.

In an aspect, the transpilation process may include generation of metadata. Metadata is data about data. When applied to the generated code, metadata may be information associated with classes, attributes, methods, or instances that describe characteristics, purpose, relationships, and behavior of various components of HPES. Metadata may explicitly define how different components (classes, variables) interact. Metadata may also track dependencies. In some examples, libraries like attrs (and data classes in the standard library) may specifically provide mechanisms to define structured attributes and, implicitly, metadata. For example, attrs is a Python library that may simplify the creation of classes whose primary purpose may be to hold data.

In some examples, the relationship may be too complex or may involve conditional logic, external calls, or iterative processes that may not be easily expressed as a single mathematical expression. In these cases, a programmatic description may be used. Such programmatic description may define the algorithm, steps, or function that takes the IVs as input and produces the DVs as output. In an aspect, solver 104 may store metadata about the programmatic description, including, but not limited to location, expected inputs/outputs, and any relevant configuration.

In an aspect, solver 104 may solve many forward problems. In an example, solver 104 may systematically vary input parameters (e.g., operating conditions) and may observe impact of the varied parameters on the outputs of the physical model. In an aspect, the simulation system may automate this process, allowing users to define multiple variables to vary and track the response of key results. In addition, when performing optimization, the simulation system may iteratively solve the forward model with different sets of design variables until an optimal solution is found. Users may want to explore the effect of a single parameter over a wide range of values using the disclosed simulation system. The analysis and/or scripting capabilities of the simulation system may be used to run simulations for each parameter value, and so on.

In an example, simulation system 201 may generate database description of evaluation results 318. In an aspect, following up on the evaluation plan 314 described above, the database describing the results of that evaluation may store the actual outcomes of applying the evaluation plan 314.

As shown in FIG. 3, inverse problem solver 204 of the simulation system 201 may solve the inverse problem. Instead of directly calculating the initial conditions or system parameters, the simulation can be used iteratively to explore the parameter space and find the inputs that lead to the desired or observed outcomes. In other words, inverse problem solver 204 may perform iterative search to solve an inverse problem (e.g., determining the initial orbit required to achieve a specific final orbit with known Delta-v). Inverse problem solver 204 may start with an initial guess for the initial orbit parameters. Inverse problem solver 204 may run the simulation using the guessed initial orbit and the known delta-v maneuvers. Next, inverse problem solver 204 may compare the resulting final orbit from the simulation with the desired final orbit. Based on the difference, inverse problem solver 204 may adjust the initial orbit parameters. In one example, the adjustment strategy could involve optimizer 112. In an aspect, optimizer 112 may implement optimization algorithms (e.g., gradient descent, genetic algorithms, particle swarm optimization) that automatically adjust the initial conditions to minimize the difference between the simulated and desired final orbits. The simulation may act as the objective function that the optimizer 112 tries to drive towards the desired outcome.

As shown in FIG. 3, inverse problem solver 204 of the simulation system 201 may also generate the database description of the evaluation KPIs 320. This may be a database (or a table within a larger database) specifically focused on storing the definitions and target values for the Key Performance Indicators (KPIs) used to evaluate the inverse problem solution. In one non-limiting example, this description 320 may include the following fields: KPI ID, KPI name, KPI description, related metric, target value/range, units (if applicable), calculation method and interpretation. Advantageously, the KPI ID may be a unique identifier for each evaluation KPI. In an aspect, the KPI name may be the name of the Key Performance Indicator (e.g., parameter accuracy, model predictive power, uncertainty reduction, etc.). As used herein the KPI description may be a detailed explanation of what the KPI measures and why this KPI may be important for evaluating the inverse problem solution. In an aspect, the related metric may be the specific evaluation metric from the evaluation plan 314 that may be used to calculate this KPI. In this example, the interpretation field may include guidance on how to interpret the value of this KPI in the context of the inverse problem solution. For example, the interpretation field may include the following information: “A lower RMSE indicates higher parameter accuracy.” In various implementations, this KPI database description 320 may provide a high-level overview of the success criteria for the inverse problem solution, linking the KPIs to the more detailed evaluation metrics.

As shown in FIG. 3, to make the results of an inverse problem solution understandable to a wider audience, simulation system 201 may generate 322 human interpretable results. In one example, the simulation system may use graphs, charts, and plots to present trends, comparisons, and uncertainties effectively. In various implementations, simulation system 201 may present solution 222 as Pareto frontier graphs, spreadsheets and/or solution exploration applications.

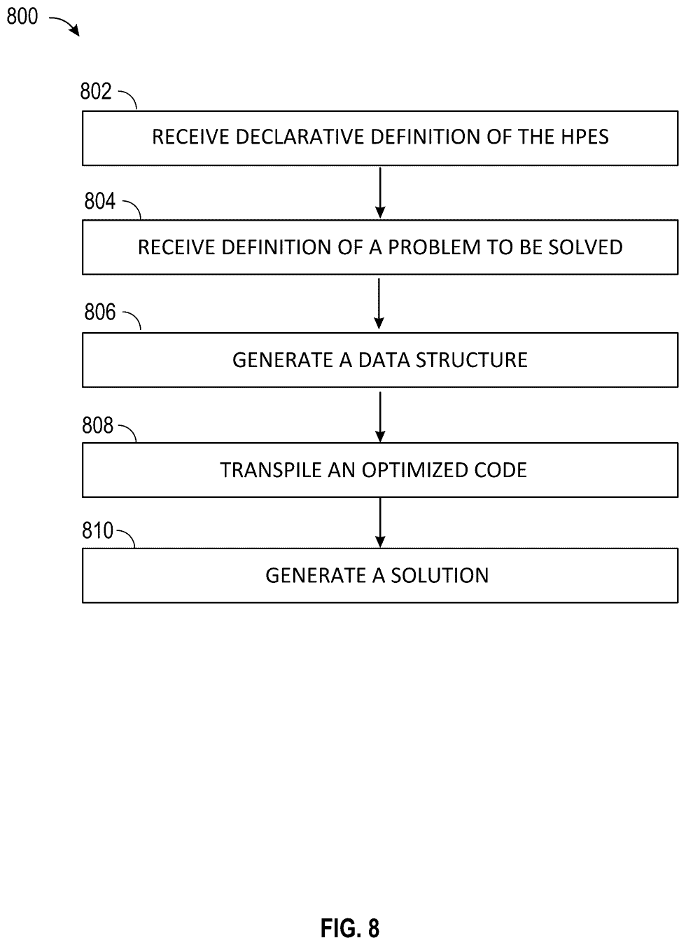

FIG. 8 is a flowchart illustrating an example mode of operation for a simulation system, according to one or more techniques described in this disclosure. Although described with respect to computing system 200 of FIG. 2 having processing circuitry 243 that executes computing system 200, mode of operation 800 may be performed by a computing system with respect to other examples of machine learning systems described herein.

In mode of operation 800, processing circuitry 243 executes computing system 200. Computing system 200 may generate, receive declarative object-oriented definition of the HPES having one or more sub-systems and/or one or more components (802). The object-oriented declarative code may allow engineers to model the HPES by defining classes that represent physical components or subsystems, encapsulating properties (attributes) and behaviors (methods) of the HPES. Next step may involve computing system 200 receiving a definition of a problem to be solved (804). The problem to be solved may include at least one of: an optimization problem or an inverse problem. A data structure representing relationships and interactions between the one or more subsystems and/or representing relationships between the one or more components of the HPES may be generated (806). The data structure may be more detailed than the functional dependency diagram illustrated in FIG. 4, potentially including physical connections and information flow. In an aspect, the next step may include the computing system 200 transpiling a first optimized code (808). The ability to transpile the system code into efficient evaluation code may become particularly valuable during DOE. The last step may include the computing system 200 generating, by the computing system 200, a solution to the first problem by executing the first optimized code (810). Advantageously, instead of a single solution, the concept of the Pareto frontier may come into play. In other words, a Pareto frontier may represent a set of solutions where improving one objective would necessarily worsen at least one other objective.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for solving problems involving a Hierarchical Physical and/or Engineering System (HPES), the method comprising:
receiving, by a computing system, a declarative object-oriented definition of the HPES having one or more sub-systems and/or one or more components;
receiving, by the computing system, a definition of a first problem to be solved, wherein the first problem comprises at least one of: an optimization problem or an inverse problem;
processing, by the computing system, the declarative object-oriented definition of the HPES to generate a data structure representing relationships and interactions between the one or more subsystems and/or the one or more components of the HPES;
transpiling, by the computing system, a first optimized code using the data structure, the declarative object-oriented definition and the definition of the first problem; and
generating, by the computing system, a solution to the first problem by executing the first optimized code.

2. The method of claim 1, further comprising:
generating, based on the declarative object-oriented definition and the data structure, a first metadata describing behavior of the HPES;
generating, based on the definition of the first problem to be solved, a second metadata describing the problem.

3. The method of claim 1, wherein the data structure is a dependency diagram representing hierarchical dependencies within the HPES.

4. The method of claim 3, wherein the data structure comprises a graph data structure having a plurality of nodes and one or more edges connecting the plurality of nodes, wherein each one of the plurality of nodes represents the one or more components of the HPES and wherein the one or more edges represent dependencies between the corresponding one or more components.

5. The method of claim 1, wherein the declarative object-oriented definition of the HPES includes one or more of: Dependent Variables (DVs), Independent Variables (IVs), Independent Design Variables (IDVs), mathematical expression, code representation of the behavior of the HPES and data types corresponding to the one or more DVs, IVs and IDVs.

6. The method of claim 5, wherein generating the first metadata comprises:
generating the first metadata defining relationships between one or more DVs and one or more IVs using one or more mathematical expressions or programmatic descriptions.

7. The method of claim 2, wherein the first metadata includes one or more constraints and wherein generating the solution to the problem further comprises:
determining whether the one or more constraints are satisfied by the generated solution.

8. The method of claim 2, wherein the second metadata includes one or more constraints and wherein generating the solution to the problem further comprises:
determining whether the one or more constraints are satisfied by the generated solution.

9. The method of claim 1, wherein generating the solution further comprises:
generating a Pareto frontier set of solutions, wherein improving one objective would necessarily worsen at least one other objective.

10. The method of claim 1, further comprising:
receiving a definition of a second problem to be solved;
generating, based on the definition of the second problem to be solved, a third metadata describing the second problem;
transpiling the first metadata and the third metadata into second optimized code; and
generating a solution to the second problem by executing the second optimized code.

11. The method of claim 10, wherein the first optimized code and the second optimized code comprise code that is optimized to run on a target hardware platform based on one or more hardware characteristics and one or more attributes of the hardware platform.

12. A computing system for solving problems involving a Hierarchical Physical and/or Engineering System (HPES), the computing system comprising:
processing circuitry in communication with storage media, the processing circuitry configured to execute a machine learning system, the machine learning system configured to:
receive a declarative object-oriented definition of the HPES having one or more sub-systems and/or one or more components;
receive a definition of a first problem to be solved, wherein the first problem comprises at least one of: an optimization problem or an inverse problem;
process the declarative object-oriented definition of the HPES to generate a data structure representing relationships and interactions between the one or more subsystems and/or the one or more components of the HPES;
transpile a first optimized code using the data structure, the declarative object-oriented definition and the definition of the first problem; and
generate a solution to the first problem by executing the first optimized code.

13. The system of claim 12, wherein the machine learning system is further configured to:
generate, based on the declarative object-oriented definition and the data structure, a first metadata describing behavior of the HPES;
generate, based on the definition of the first problem to be solved, a second metadata describing the problem.

14. The system of claim 12, wherein the data structure is a dependency diagram representing hierarchical dependencies within the HPES.

15. The system of claim 14, wherein the data structure comprises a graph data structure having a plurality of nodes and one or more edges connecting the plurality of nodes, wherein each one of the plurality of nodes represents the one or more components of the HPES and wherein the one or more edges represent dependencies between the corresponding one or more components.

16. The system of claim 12, wherein the declarative object-oriented definition of the HPES includes one or more of: Dependent Variables (DVs), Independent Variables (IVs), Independent Design Variables (IDVs), mathematical expression, code representation of the behavior of the HPES and data types corresponding to the one or more DVs, IVs and IDVs.

17. The system of claim 16, wherein the machine learning system configured to generate the first metadata is further configured to:
generate the first metadata defining relationships between one or more DVs and one or more IVs using one or more mathematical expressions or programmatic descriptions.

18. The system of claim 13, wherein the first metadata includes one or more constraints and wherein the machine learning system configured to generate the solution to the problem is further configured to:
determine whether the one or more constraints are satisfied by the generated solution.

19. The system of claim 13, wherein the second metadata includes one or more constraints and wherein the machine learning system configured to generate the solution to the problem is further configured to:
determine whether the one or more constraints are satisfied by the generated solution.

20. Non-transitory computer-readable storage media having instructions encoded thereon for solving problems involving a Hierarchical Physical and/or Engineering System (HPES), the instructions configured to cause processing circuitry to:
receive a declarative object-oriented definition of the HPES having one or more sub-systems and/or one or more components;
receive a definition of a first problem to be solved, wherein the first problem comprises at least one of: an optimization problem or an inverse problem;
process the declarative object-oriented definition of the HPES to generate a data structure representing relationships and interactions between the one or more subsystems and/or the one or more components of the HPES;
transpile a first optimized code using the data structure, the declarative object-oriented definition and the definition of the first problem; and
generate a solution to the first problem by executing the first optimized code.
